(19) United States
(12) Patent Application Publication
(10) Pub. No.: US 2016/0001443 A1
(43) Pub. Date: Jan. 7, 2016

(54) SUSPENDED FLYING RIG SYSTEM

(71) Applicant: TAIT TOWERS MANUFACTURING, LLC, Lititz, PA (US)

(72) Inventor: Adam DAVIS, Leola, PA (US)

(21) Appl. No.: 14/324,935

(22) Filed: Jul. 7, 2014

(51) Int. Cl. B25J 9/00; A63J 5/00

(52) U.S. Cl. CPC B25J 9/0078; A63J 5/00

(57) ABSTRACT

A suspended flying rig system includes a plurality of cables attached to a load support releasably securing a load. In response to retraction and/or deployment of at least one of the plurality of cables, motion is provided generally within a three-dimensional working space to the load support. The motion includes at least six degrees of freedom.

### FIELD OF THE INVENTION

The disclosure is generally related to a suspended flying rig. More particularly, the disclosure includes a system for positioning and orienting a load, particularly within a working space.

### BACKGROUND OF THE INVENTION

A motion providing device known in the art is a simulator-type apparatus that utilizes hydraulic cylinders to provide an upward force on a triangular support. The triangular support, in turn, typically supports a load. The cylinders provide force at angles which, when operating cooperatively, provide a range of motion for the support and the load mounted thereon. Other devices, such as hexapods and Stewart Platform devices operate in a similar manner. However, these devices have a limited range of motion that is limited by the stroke of the hydraulic cylinder. Larger ranges of motion require larger hydraulic cylinders, which are expensive and more difficult to operate. In addition, hydraulic systems are expensive and require frequent maintenance.

Another motion providing device includes suspended camera rigs wherein a camera is suspended from four cables at opposing corners of an area. The cables are drawn and retracted by winches to provide a motion of the camera. The motion of the camera by use of these cables is limited to (x, y, z-type) positioning within the space and cannot provide roll, pitch or yaw of the camera.

What is needed is a system and apparatus that provides a large range of positioning or orienting a load within a working space that does not suffer from the drawbacks of the prior art.

### SUMMARY OF THE INVENTION

An aspect of embodiments of the present disclosure includes a suspended flying rig system for positioning and orienting a load support within a working space using an arrangement of cables.

Another aspect includes a suspended flying rig system including a plurality of cables attached to a load support releasably securing a load. In response to refraction and/or deployment of at least one of the plurality of cables, motion is provided generally within a three-dimensional working space to the load support. The motion includes at least six degrees of freedom.

A further aspect includes a suspended flying system including a plurality of cables attached to a load support releasably securing a load. The system includes at least three support structures, the support structure assembled to at least one winch assembly, each winch assembly for selectively retracting and/or deploying a corresponding cable of the plurality of cables. In response to retraction and/or deployment of at least one of the plurality of cables, motion is provided generally within a three-dimensional working space to the load support. The motion includes at least six degrees of freedom.

A further aspect includes a suspended flying rig system including a plurality of cables attached to a load support releasably securing a load. The system includes at least three support structures, each support structure assembled to at least one winch assembly, each winch assembly for selectively refracting and/or deploying a corresponding cable of the plurality of cables. At least one support structure is freestanding. In response to retraction and/or deployment of at least one of the plurality of cables, motion is provided generally within a three-dimensional working space to the load support. The motion includes at least six degrees of freedom. The load is selected from the group consisting of a ride vehicle and ride car.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 shows an isometric view of a suspended flying rig system according to an exemplary embodiment of the disclosure.

FIG. 2 shows a side view of a suspended flying rig system according to an exemplary embodiment of the disclosure.

FIG. 3 shows an enlarged, partial lower perspective view of a suspended flying rig system according to an exemplary embodiment of the disclosure.

FIG. 4 shows an upper perspective view of a suspended flying rig system according to an exemplary embodiment of the disclosure.

FIG. 5 shows a plan view of a suspended flying rig system according to an exemplary embodiment of the disclosure.

FIG. 6 schematically shows a portion of a suspended flying rig system according to an exemplary embodiment of the disclosure.

Wherever possible, the same reference numbers will be used throughout the drawings to represent the same parts.

### DETAILED DESCRIPTION OF THE INVENTION

Provided is a suspended flying rig system for positioning and orienting a load support using an arrangement of cables. What follows are exemplary embodiments.

An advantage of embodiments of the present disclosure includes a capability of selective combination of movement of a load in the horizontal direction, vertical direction and the lateral direction permitting positioning and orientation in three dimensions within a three-dimensional working space, the load being releasably secured by a load support.

Another advantage of embodiments of the present disclosure includes capability of providing motion that allows pitching, yawing and rolling motion to a load support releasably securing a load.

Still another advantage of embodiments of the present disclosure include the ability to assemble the flying rig system in a variety of locations, with little space requirements for equipment.

Yet another advantage of embodiments of the present disclosure include a flying rig system requiring a minimum of non-usable ground space.

Another advantage of embodiments of the present disclosure include an extrication device for delivering a load along one or more cables extending between a load support and a support structure, as an alternative to the flying rig system delivering the load to the ground or other location.

Still yet another advantage of embodiments of the present disclosure include a flying rig system in which the load is releasably secured to one or more surfaces of the load support that are substantially vertically above and/or substantially vertically below other surfaces of the load support.

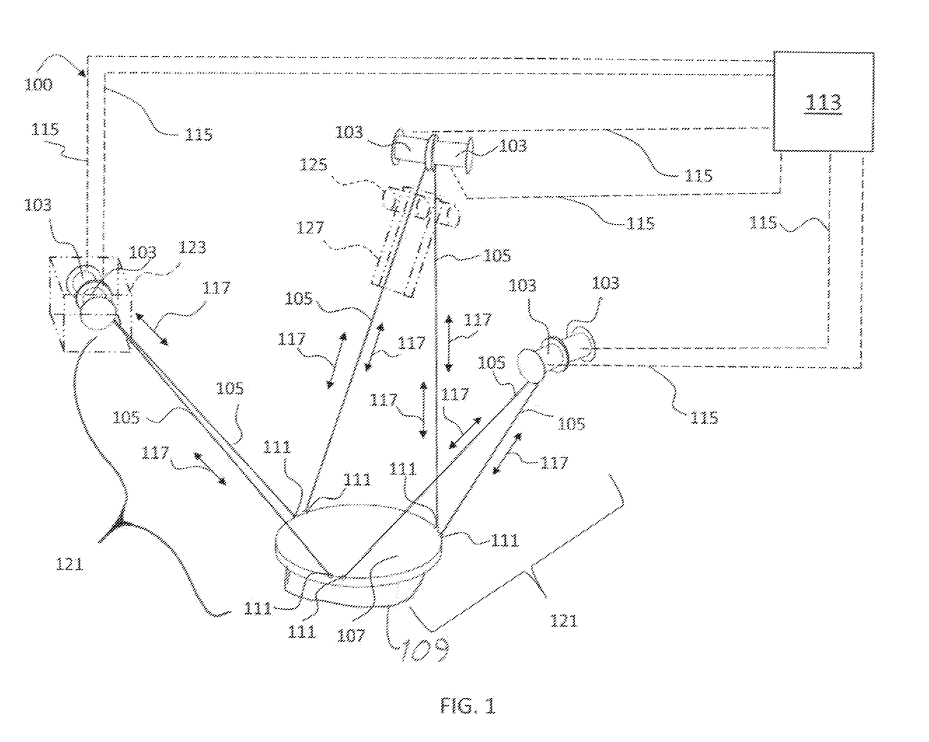

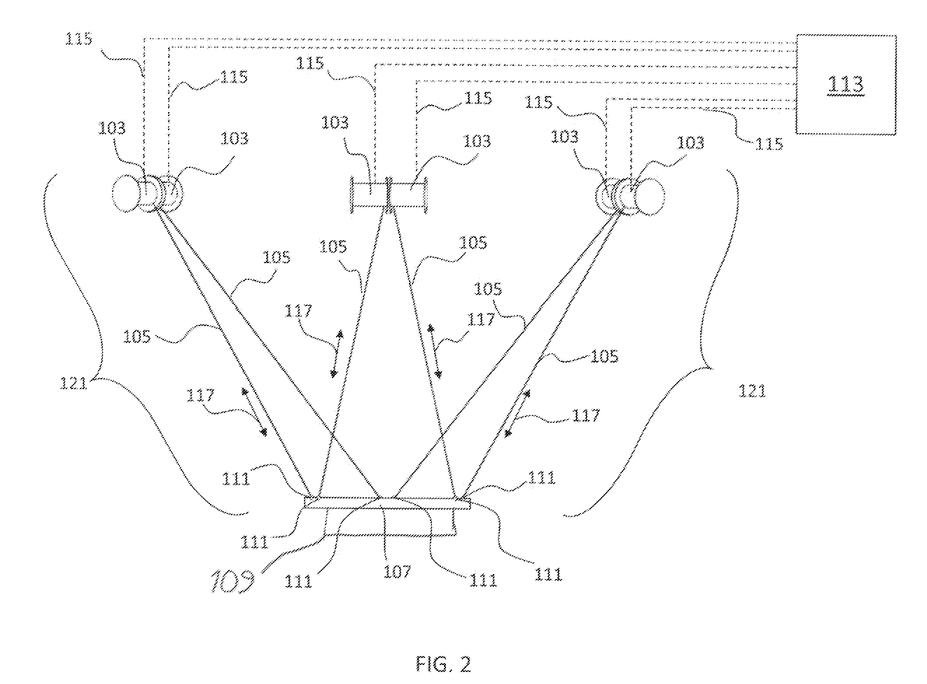

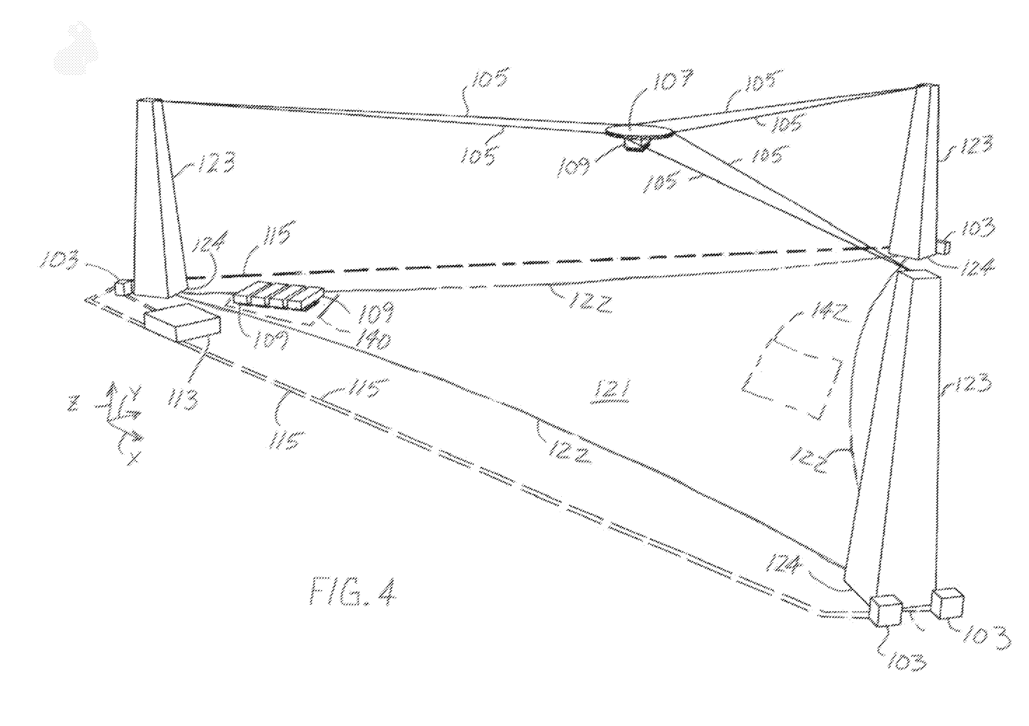

FIGS. 1-2 show a suspended flying rig system 100 according to an embodiment of the present disclosure. The flying rig system 100 may be mounted to any suitable support structure. For example, the plurality of winch assemblies 103 may be mounted to one or more support structures (a support structure 123 is shown in FIG. 1), such as a truss, ceiling structure, beam or other suitable support. In another embodiment, one or more support structures 123 may be freestanding structures (FIG. 4). The winch assemblies 103 are connected to support structure by any suitable mechanism. Suitable mechanisms include, but are not limited to, fasteners, interlocking structure, quick-release mechanisms, semi-permanent attachment devices, such as welds, or other attachment devices. The flying rig system 100 also includes a plurality of cables 105 extending from each of the winch assemblies 103 to a load support 107.

The load support 107 carries, supports, attaches to or otherwise interacts with a load 109. In one embodiment, load support 107 releasably carries, supports, attaches to or otherwise interacts with load 109. For purposes herein, the term “securing” as in “releasably securing” is intended to include releasably carrying, supporting, attaching or otherwise interacting with load 109. In certain embodiments, the load may include seating and a protective cage or enclosure. However, the load 109 that is mountable on or to the load support 107 is not so limited. For example, other embodiments the load may include cameras, equipment, lighting, personnel, ride vehicles, ride cars or other objects that are desirably positioned and/or oriented.

Load 109 may be mounted on a load support 107, which is moved by selective retraction and deployment of cable 105 from the plurality of winch assemblies 103. By retracted, retracting, retraction or grammatical variations thereof, it is meant that cable 105 is drawn so that the length of cable 105 suspended is shortened such as by a winch assembly 103. By deployed, deploying, deployment or grammatical variations thereof, it is meant that cable 105 is extended so that the length of cable 105 suspended is increased. The cable 105 is an elongate support device capable of supporting weight and being stored and driven on the winch assembly. Suitable structures for use as cable 105 include, but are not limited to, a wire, cable, rope, tape or other structure capable of supporting weight. The cable 105 may be synthetic or non-synthetic material. Suitable materials for cable 105 may be a metal, polymer or other suitable high strength material of construction. In other embodiments, the cable 105 includes power or signal wires either integrated into the cable 105, adjacent to the cable 105 or run parallel to the cable 105 in order to provide power and/or control to the camera or other devices present as the load 109. In one embodiment, one or more of the cables 105 are configured for transmitting signals (for example, through electrical signals) to the load support 107, particularly when power and/or control signals are desirable for use with the load support 107 or the load 109 on the load support. For example, in one embodiment, the cable(s) 105 include fiber-optic interiors with a durable exterior (for example, a flexible polymeric coating or a flexible metal coating). In one embodiment, one or more of the cables 105 includes an aramid fiber (for example, a polyimide fiber). In one embodiment, one or more of the cables 105 are steel cables. In another embodiment, one or more of the cables 105 are braided Kevlar-jacketed.

A suitable winch assembly 103 is a powered winch or other device capable of retaining and retracting/deploying cable. One embodiment of the disclosure includes a winch assembly 103 being a powered winch having a motor, which drives a reel or set of reels which receive, store, drive or otherwise move cable 105. The arrangement of motors and reel can include any suitable arrangement known for powered winches and may include gearing, clutch assemblies, brakes, belts, chains or other structures useful for translating rotation motion from the motor to rotational motion of the reel. In addition, the reel preferably includes a helical groove or similar structure to retain cable 105. Although the above has been described with respect to a motor and reel to move cable 105, other structures may be utilized to provide movement to cable 105. The amount or length of cable 105 that is suspended may be altered by other methods, such as non-rotation mechanical system, hydraulic cylinders, or by other actuation devices capable of altering the amount of cable 105 that is suspended. For example, portions of the cable 105 may be folded or redirected to remove a portion of the length that is suspended from the support structure onto which the winch assemblies 103 are attached. Manipulation of the length of cable 105 suspended facilitates motion of the load support attached thereto.

Winch assemblies 103 are controlled by a controller 113 or control system. A suitable controller 113 or control system includes one or more microprocessors and graphical user interface that provides individual control to winch assemblies in response to the desired motion of load support 107. Control lines 115 provide signals and/or power to the winch assemblies. In one embodiment, the winch assemblies 103 include control systems having microprocessors that provide control to the winch assembly 103 and retract or deploy the cable 105 in response to a signal. In another embodiment, the winch assemblies 103 may receive power and/or signals from controller 113 to retract or deploy the cable 105. The arrangement of control lines 115 may include individually run cables to the winch assemblies (as shown in FIG. 1) or may include a daisy-chain arrangement wherein the line includes a single or few branches from which connections to the winch assemblies 103 are made (see e.g., FIG. 2). The arrangement of the controller 113 may also be integrated into a large control system, such as a show or attraction where a graphical user interface and series of microprocessors are arranged to provide centralized control of the motion of load support 107.

While the above has been described with respect to winch assemblies 103 being attached to the support structures, such as trusses, other structures may be utilized to guide and suspend cables 105. In another embodiment, one or more pulleys (one set of pulleys 125 is shown in FIG. 1) may be mounted to a single support structure. The pulleys may be arranged and mounted to support the cable 105 as it is deployed or retracted by winch assembly 103. In another embodiment, the pulleys may be arranged within or on tracks or other guides (one set of tracks/guides 127 is shown in FIG. 1) that physically move the pulleys to different locations on the fly to provide dynamic re-sizing and re-shaping of the working space 121. Suitable pulleys include conventional pulley structures or other devices capable of rollably or slidably supporting a cable, wire or rope. While the pulleys in this embodiment are preferably free-rolling pulleys, a brake, motor or other rotation facilitating or retarding device may be provided to pulleys to provide additional control for positioning the load support 107. In these embodiments, the winch assembly 103 may be located at a location some distance from the pulley. In one embodiment, the winch assemblies 103 are located at ground level. In another embodiment, a portion of the winch assemblies 103 are mounted at ground level and a portion of the winch assemblies are mounted on a support structure and cables 105 extend to the pulleys. In yet another embodiment, the winch assemblies 103 are consolidated into a single location and cables 105 extend to the pulleys to allow shorter control lines 115 and easier servicing of the winch assemblies 103. The cable 105 is connected to the attachment points 111 on load support 107 by any suitable mechanism. Suitable mechanisms include, but are not limited to, loop and closed-hook mechanisms, connectors guided by magnets for alignment, bolts or other fasteners, and cable splices.

Motion of the load support 107 is facilitated by deploying or retracting cables 105 along pull directions 117. Motions, such as pitch, roll and yaw, can be provided by selectively retracting and deploying cable 105 with winch assembly 103. The motions result as the cables 105 are independently deployed or retracted, causing independent motion in each of the pull directions. The cooperative motion in the pull directions permit a range of motion in a three-dimensional space with at least six degrees of freedom. Other motions, such as lifting, can be accomplished by selectively retracting cable 105 with winch assembly 103. As shown in FIGS. 1-2, the load support 107 can be positioned and oriented, generally within working space 121. Working space 121 includes a three-dimensional space or three-dimensional working space through which the load support 107 may be positioned and oriented. Although FIGS. 1-2 depict a general dimension for the working space, the disclosure is not limited to the locations shown in the figures and movement, positioning and orientation may occur outside the working space 121, i.e., motion is provided generally within a three-dimensional working space 121, particularly if external forces are provided or actions, such as swinging or cable manipulation, are utilized. In addition, the dimensions of working space 121 may be altered, for example, by placement of pulleys, movement of the support structure or movement of the winch assemblies.

In an exemplary embodiment, the support structure may be mounted on rails or other movable assembly and configured to provide additional translational motion to the load support 107. For example, the working space 121 may be extended in this embodiment to include an extended space corresponding to the motion of the support structure. Likewise, the support structure may be rotated, lifted, lowered or otherwise moved to provide an additional range of motion to the load support 107 and an extension to the working space.

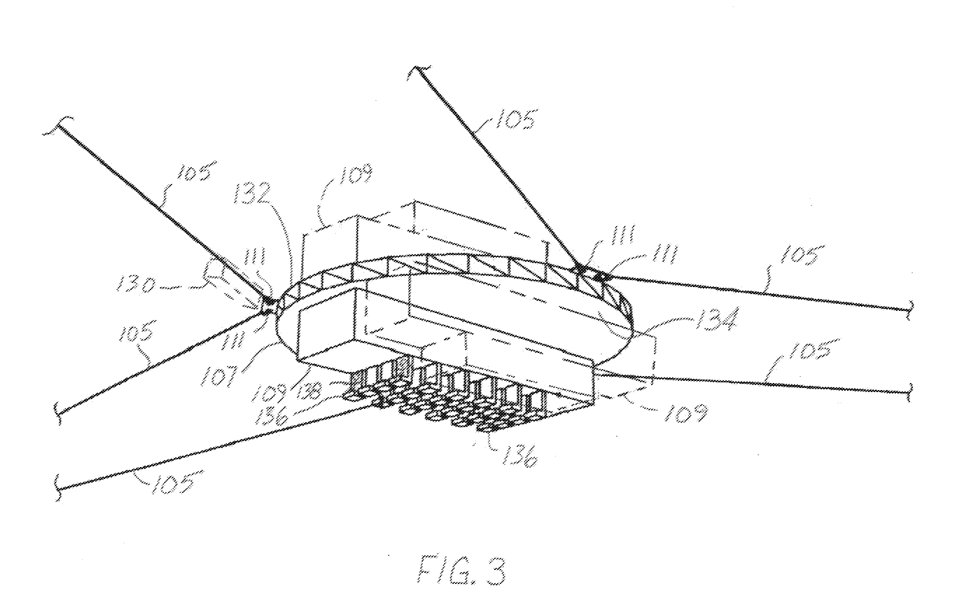

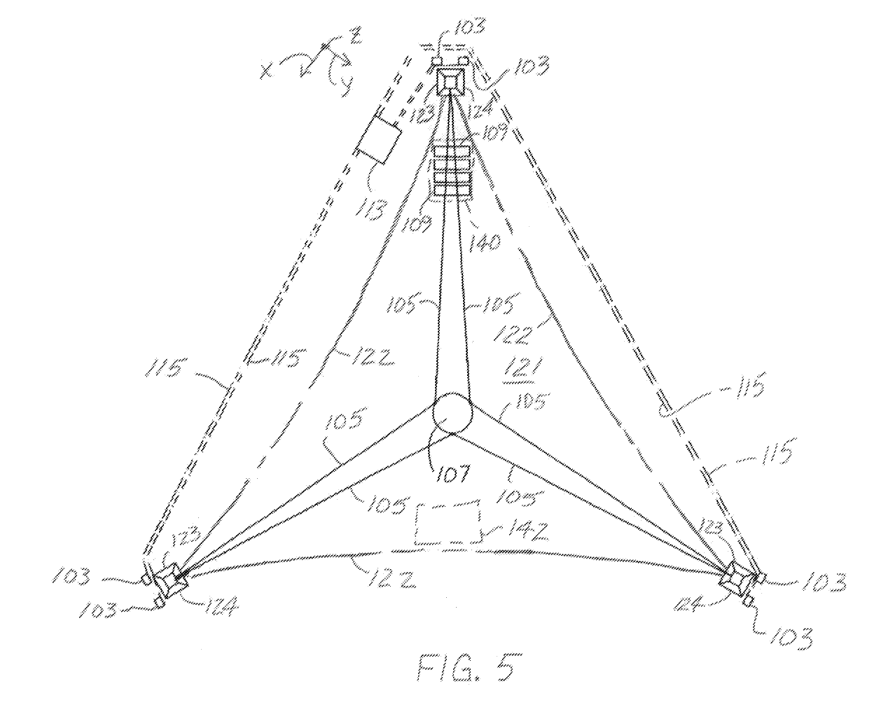

FIG. 3 shows a lower perspective view of an exemplary embodiment of the load 109 as a ride vehicle or ride car. FIG. 3 shows the load 109 including a plurality of securing arrangements 136 such as chairs for moving riders 138 within a three-dimensional working space 121 (see e.g., FIGS. 4 and 5) defined by interconnected boundary lines 122 extending in the x-y plane, the interconnected boundary lines movable in the z direction to collectively form the three-dimensional working space. In one embodiment, securing arrangements 136 may be configured for non-human riders. In another embodiment, securing arrangements may be configured for cargo. Load 109 as a ride vehicle or ride car optionally includes a protective enclosure or cage (not shown) that may at least partially transparent to enhance viewability. As further shown in FIG. 3, load 109 is releasably secured to one or both of surfaces 132, 134 of load support 107. As shown in FIG. 3, the surface 132 to which a load 109 is releasably secured, is positioned at least substantially vertically above other surfaces of load support 107 when the load support is positioned substantially horizontally (see e.g., FIG. 4), while surface 134 to which a load 109 is also releasably secured, is positioned at least substantially vertically below other surfaces of load support 107 when the load support is positioned substantially horizontally (see e.g., FIG. 4). Although the loads may be releasably secured to other than opposed surfaces 132, 134, and other orientations of the load support may be utilized while the load support is moving through the three-dimensional working space 121, such as when the system is utilized as a “thrill ride” (i.e., changing load support orientations), when the system is utilized for purposes of viewing the environment surrounding the system, it may be desirable to position the load (including riders in ride vehicles or ride cars) such as to maximize the riders' viewing experience (i.e., maximize the riders' unobscured and/or peripheral vantage point). In one embodiment (not shown) the securing arrangements 136 may be constructed such that riders bodies can be maintained in a position that is substantially parallel to the corresponding surface of the load support to which the load is secured, thereby providing a vantage point that is substantially perpendicular to the corresponding surface of the load support. In one embodiment, the loads may be releasably secured to surfaces 132, 134 simultaneously. For example, once load support 107 is lowered to a desired docking position, a surface of the load support 107, such as surface 134, is either brought into abutment with a corresponding surface of load 109 such that load 109 may be releasably secured, or surface 134 is placed in a position such that load 109 can be moved in sufficiently close proximity such that load 109 may be releasably secured to the load support. In one embodiment, such as shown in FIG. 3, loads 109 are releasably secured to each of surfaces 132, 134.

As shown in FIG. 3, an extrication device 130, such as a self-propelled winch assembly secured to a cable 105 permits the load, such as a rider 138 or cargo, to be delivered from a ride vehicle/ride car along the cable extending between the load support 107 and a support structure 123. Such an extrication for removal device may be required in the event of a malfunction associated with deployment/retraction of the cables, resulting in an inability to move load support 107 from an elevated position in the three-dimensional working space 121 from which extraction of the riders from the ground or from the air cannot be achieved. In one embodiment, in which human riders must be rescued or extracted from the ride vehicle/ride car, one or more extrication devices 130 may be required, which may involve rescue personnel being transported from a support structure to the load support, and also including additional equipment (not shown), such as, but not limited to straps, harnesses, clips and devices for unlocking ride vehicles/ride cars, such as for access to the riders or to disengage one or more of the ride vehicles/ride cars from the load support, and providing sufficient redundancy loading arrangements required so as to comply with applicable safety specifications and/or codes. In one embodiment, portions of the ride vehicle/ride cars containing one or more riders may be removable from the load support without requiring riders to be individually removed or extracted from the ride vehicles/ride cars. Additionally, in one embodiment, features associated with the support structures, such as enclosed steps or elevators accessible from the ground that are also in compliance with such safety specifications and/or codes may be incorporated into the flying rig system.

In one embodiment of load support 107, at least one or both of surfaces 132, 134 are configured to interchangeably and selectably receive/secure loads 109, such as a ride vehicle or ride car. In another embodiment, at least surface 134 of load support 107, as shown in FIG. 3, is configured to releasably receive/secure more than one load 109 (i.e., more than one ride vehicle or ride car).

As shown in FIGS. 4 and 5, the system may be used to move the loads 109, such as ride vehicles or ride cars within the three-dimensional working space 121. In one movement path, load 109 is moved from a first position 140 into three-dimensional space, returning to first position 140. In one embodiment, this movement path may correspond to the system being used as an amusement park ride, in which the starting point and ending point of the ride (and the loads) are the same. In another movement path, load 109 is moved from the first position 140 into the three-dimensional working space 121 to a second position 142. In one embodiment, this movement path may correspond to the system being used to transport riders, for example from a parking lot collection area to the entrance of an amusement park. In another embodiment, this movement path may correspond to transporting riders in a congested urban setting, e.g., from a hotel to an entertainment/dining venue (or vice versa), providing a scenic view of the city between departure and destination points, without the aggravation of traffic. In another embodiment, this movement path may correspond to movement of the load 109 over a waterway or other obstacle preventing conventional overland travel, such as by automobile. In other embodiments, this movement path may correspond to different combinations of vehicles/vessels and/or land-based positions, such as between two (or more) different sea vessels, between one or more land-based position(s) and a sea vessel(s), between one or more land-based position(s) and a flying vehicle(s), such as a hovercraft, helicopter, blimp or other air vehicle capable of independently controlling its position in space (as well as air vehicles incapable of independently controlling its position in space, such as a hot air balloon), between one or more sea vessel(s) and a flying vehicle(s), between one or more land-based position(s), a sea vessel(s) and a flying vehicle(s), or any combination thereof. In one embodiment, the loads may include the movement or transfer of riders and/or cargo, or for rescue missions, such as extracting riders and/or cargo from a land-based position, or from a body of water, or from a flying vehicle. In order for the system to operate as disclosed between only two vehicles/positions, at least one of the vehicles/positions would need to include at least two support structures, such as previously discussed.

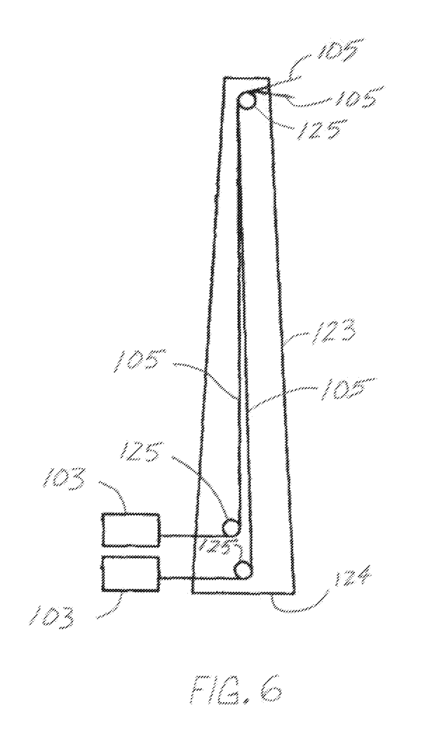

As further shown in FIGS. 4-6, the three support structures 123 are freestanding. In another embodiment, none of the support structures 123 may be freestanding. In other embodiments, one or more of the support structure 123 may be freestanding. For purposes herein, “freestanding” as in “freestanding structure” is intended to mean a structure that is not supported by another object. The term object is intended to include another freestanding structure. That is, a tower that may include one or more support cables is a freestanding structure. Additionally, a mass sufficiently protruding or jutting from the surrounding terrain (erected or natural formation) securable to an upper pulley 125 (FIG. 6) or winch 103 from which cable 105 may be deployed or refracted for use with the system as previously discussed, may be considered a freestanding structure. The support structures 123, such as the towers shown in FIGS. 4-6, are examples of freestanding structures.

FIGS. 4-6 show a flying rig system requiring a minimum of non-usable ground space. That is, as shown, only the collective cross sectional areas 124 or combined footprint of support structures 123 are permanent, and thus non-usable for other purposes. For purposes herein, the term footprint is intended to mean the cross sectional area of a non-movable object supported by the ground or in sufficiently close proximity with the ground as to prevent usage of the ground for purposes. It is to be understood that for pulleys 125 or winch assemblies 103 (FIG. 1) that are secured to existing structures, in practical effect, there is little, if any, additional loss of usable ground space as a result of the flying rig system. This resulting ground space savings is due to the existing structure being utilized for supporting the flying rig system. That is, the existing structures are already occupying essentially the same ground space as that occupied prior to installation of the flying rig system, especially if the components of the flying rig system are mounted sufficiently vertically above the ground so as not to interfere with the ground in close proximity to the existing structure being used for other purposes. It is to be understood that naturally occurring freestanding structures, such as masses protruding or jutting from the surrounding terrain (ground) similarly represent ground space that would already be considered non-usable for other purposes. The same reasoning (non-usable for other purposes) would be applicable for support structure forming a portion of a sheer cliff or other geological feature that may otherwise not be considered to be “freestanding”. In summary, due to the minimum combined footprint associated with the support structure of the flying rig system of the present disclosure, the flying rig of the present disclosure provides maximum flexibility for multiple uses of the ground not related to the flying rig.

In summary, the only non-usable ground space of the flying rig system is essentially that associated with the combined footprint of the support structures, since ground space associated with dropping off and/or picking up the loads prior to movement in the three-dimensional space, such as first position 140 and second position 142 (FIGS. 4 and 5) are not required to be permanently fixed positions that would render the ground space associated with those positions non-usable for other purposes.

While only certain features and embodiments of the invention have been shown and described, many modifications and changes may occur to those skilled in the art (for example, variations in sizes, dimensions, structures, shapes and proportions of the various elements, values of parameters (for example, temperatures, pressures, etc.), mounting arrangements, use of materials, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

What is claimed is:

1. A suspended flying rig system comprising:
a plurality of cables attached to a load support releasably securing a load;
in response to retraction and/or deployment of at least one of the plurality of cables, motion is provided generally within a three-dimensional working space to the load support;
wherein the motion includes at least six degrees of freedom.

2. The system of claim 1, wherein the load is movable from a first position within the three-dimensional working space, the load returnable to the first position or the load movable to a second position.

3. The system of claim 1, wherein the load is releasably secured to at least one of a first surface and a second surface.

4. The system of claim 3, wherein the first surface is at least substantially vertically above other surfaces when the load support is positioned substantially horizontally.

5. The system of claim 3, wherein the second surface is at least substantially vertically below other surfaces when the load support is positioned substantially horizontally.

6. The system of claim 1, comprising at least three support structures, each support structure assembled to at least one winch assembly, each winch assembly for selectively retracting and/or deploying a corresponding cable of the plurality of cables.

7. The system of claim 6, wherein at least one support structure of the at least three support structures is freestanding.

8. The system of claim 6, wherein non-usable ground space associated with the system is generally limited to a combined footprint of the support structure.

9. The system of claim 1, wherein the load is selected from the group consisting of a ride vehicle and ride car.

10. The system of claim 9, comprising an extrication device for delivering a rider from the ride vehicle/ride car along at least one cable between the load support and a support structure.

11. A suspended flying rig system comprising:
a plurality of cables attached to a load support releasably securing a load; and
at least three support structures, the support structure assembled to at least one winch assembly, each winch assembly for selectively retracting and/or deploying a corresponding cable of the plurality of cables;
in response to retraction and/or deployment of at least one of the plurality of cables, motion is provided generally within a three-dimensional working space to the load support;
wherein the motion includes at least six degrees of freedom.

12. The system of claim 11, wherein the load is movable from a first position within the three-dimensional working space, the load returning to the first position or the load moving to a second position.

13. The system of claim 11, wherein the load is releasably secured to at least one of a first surface and a second surface.

14. The system of claim 13, wherein the first surface is at least substantially vertically above other surfaces when the load support is positioned substantially horizontally.

15. The system of claim 13, wherein the second surface is at least substantially vertically below other surfaces when the load support is positioned substantially horizontally.

16. The system of claim 11, wherein at least one support structure of the at least three support structures is freestanding.

17. The system of claim 11, wherein non-usable ground space associated with the system is generally limited to a combined footprint of the support structure.

18. The system of claim 11, wherein the load is selected from the group consisting of a ride vehicle and ride car.

19. The system of claim 18, comprising an extrication device for delivering a rider from the ride vehicle and/or the ride car along at least one cable between the load support and a support structure.

20. A suspended flying rig system comprising:
a plurality of cables attached to a load support releasably securing a load; and
at least three support structures, each support structure assembled to at least one winch assembly, each winch assembly for selectively retracting and/or deploying a corresponding cable of the plurality of cables, wherein at least one support structure is freestanding;
in response to retraction and/or deployment of at least one of the plurality of cables, motion is provided generally within a three-dimensional working space to the load support;
wherein the motion includes at least six degrees of freedom;
wherein the load is selected from the group consisting of a ride vehicle and ride car.
